(19) United States
(12) Patent Application Publication
(10) Pub. No.: US 2009/0227914 A1
(43) Pub. Date: Sep. 10, 2009

(54) Massage Machine

(76) Inventor: Shoji Kanaoka, Osaka (JP)

Correspondence Address: BIRCH STEWART KOLASCH & BIRCH, PO BOX 747, FALLS CHURCH, VA, 22040-0747, US

(21) Appl. No.: 11/992,198

(22) PCT Filed: Dec. 6, 2006
(86) PCT No.: PCT/JP2006/324325

§ 371 Date: Mar. 18, 2008

(30) Foreign Application Priority Data
Mar. 31, 2006 (JP) 2006-099629
Mar. 31, 2006 (JP) 2006-099630

(51) Int. Cl. A61H 7/00

(52) U.S. Cl. 601/84; 601/150

(57) ABSTRACT

There are included: a massaging part (5) for performing a massage and a control unit (12) for performing control such that a massage corresponding to a change of a sound signal is performed in the massaging part. When detecting that the sound signal is brought to a predetermined state to start a massage by a change of the sound signal, the control unit (12) brings the massaging part to an operating state during a predetermined massaging time regardless of the change of the sound signal.

### TECHNICAL FIELD

The present invention relates to a massage machine.

### BACKGROUND ART

Japanese Patent Laid-Open No. 2003-79687 discloses a massage machine for performing a massage based on a sound signal.

Japanese Patent Laid-Open No. 2003-79687 discloses an air massage machine including air bags, a supply and exhaust apparatus for supplying and exhausting air to and from the air bags, and a control unit for controlling the operations of the supply and exhaust apparatus, wherein a control signal is generated based on the sound signal and the operation of the supply and exhaust apparatus is controlled by the generated control signal.

In this air massage machine, when the sound signal changes so as to exceed a predetermined threshold value, an air pump is driven to supply air to the air bags, the air bags expand, and the user is pressed by the air bags. Further, when the sound signal is lower than the predetermined threshold value, the driving of the air pump is stopped, air is exhausted from the air bags, and the air bags contract.

The air massage machine includes a plurality of air bags, and the air bags to be supplied with air are sequentially switched by a rotary valve.

### DISCLOSURE OF THE INVENTION

In the conventional air massage machine, it is possible to expand the air bags and switch the air bags to be supplied with air in response to a change of the sound signal. However, it has been desired to improve the feeling of the body in massage performed with sound effects.

Thus it is an object of the present invention to provide a massage machine that can improve the feeling of the body in massage performed with sound effects.

The present invention is characterized in that the present invention includes a massaging part for performing a massage and a control unit for performing control such that a massage corresponding to a change of a sound signal is performed in the massaging part, and when detecting that the sound signal is brought to a predetermined state to start a massage by a change of the sound signal, the control unit brings the massaging part to an operating state during a predetermined massaging time regardless of the change of the sound signal.

According to the present invention, when the sound signal is brought to the state to start a massage by, for example, exceeding a predetermined threshold value, the massaging part is brought to the operating state during the predetermined massaging time.

Therefore, even when the sound signal is in the state to start a massage for a short time, an operation in the predetermined massaging time can be secured.

“Massage” in the present invention includes a slight press and movements such as swinging or vibrations and so on for relaxation, and further includes movements capable of providing any physical actions for the user.

Further, it is preferable that in the state to start a massage, the signal level of the sound signal exceeds a threshold value.

It is preferable that the control unit includes a massage start control signal generation part for detecting that the sound signal is brought to the predetermined state to start a massage and generating a massage start control signal, and a massage operation control signal generation part for generating, when the massage start control signal is generated, a massage operation control signal for operating the massaging part during the predetermined massaging time.

It is preferable that the control unit is configured to have a non-operating time period in which even when the sound signal is brought to the state to start a massage immediately after the massaging time, the massaging part does not operate again. In this case, immediately after the massaging time, the massaging part does not operate regardless of a state of the sound signal. Thus it is possible to prevent a continuous operation of the massaging part and perform varied massage while achieving synchronization with the sound signal.

It is preferable that the control unit detects, as a state of the sound signal to start a massage, a plurality of states to start a massage with various states of the sound signal, and the massage is varied with the detected states to start a massage.

In this case, a massage can be varied with the plurality of states of the sound signal, achieving massage varied with a change of the sound signal.

It is preferable that the massage is varied by changing the massaging time according to the detected states to start a massage. Further, when the massage is varied, the intensity of the massage may be changed or different kinds of massage (such as kneading and tapping) may be performed.

The control unit includes a massage start control signal generation part for generating a first massage start control signal when the sound signal is brought to a first massage start state and generating a second massage start control signal when the sound signal is brought to a second massage start state, which is different from the first massage start state, and a massage operation control signal generation part for generating, when the first or second massage start control signal is generated, a massage operation signal for operating the massaging part during the predetermined massaging time. The massage operation control signal generation part is preferably configured such that the massaging time of the massage operation control signal generated in response to the first massage start control signal and the massaging time of the massage operation control signal generated in response to the second massage start control signal are different in length.

It is preferable that the massaging part is configured as an air massaging part for performing a massage in response to air supply from an air supply source and the control unit is configured to supply air to the air massaging part such that the air massaging part can expand so large as to press the body during the massaging time.

It is preferable that the massaging part is made up of an air cell expanded by air supply from an air supply source and the air cell substantially finishes expanding in an air supply time of 0.5 seconds or less. In the case of a conventional air cell for massage, expansion requires nearly several seconds to several tens seconds. In a massage synchronized with the sound signal, the massaging time (air supply time) is, for example, 0.5 [s] or less at one time, which is extremely short. Thus it is preferable to reduce the size of the air cell and increase an amount of air supply from the air supply source such that the air cell substantially finishes expanding in air supply during the massaging time (0.5 [s]) of a massage.

Further, it is preferable that in the massaging part, the air cell substantially finishes expanding in the air supply time of 0.3 seconds or less and it is more preferable to adopt an air cell substantially finishing expanding in the air supply time of 0.2 seconds or less.

Also, the present invention is a massage machine characterized in that the massage machine includes a plurality of massaging parts for performing a massage and a control unit for controlling the massaging parts, and the control unit selects, based on a change of a sound signal, the massaging parts to be operated from the plurality of massaging parts.

According to the present invention, the massaging parts to be operated are selected from the plurality of massaging parts based on a change of the sound signal, so that the user can feel a change of the sound signal as well from a change of the operating massaging parts, improving a correlation between the sound signal and a massage.

It is preferable that the operation control signal is generated when the signal level of the sound signal exceeds a threshold value.

It is preferable that the control unit includes an operation control signal generation part for generating an operation control signal of the massaging part based on a change of the sound signal, and a selection part for selecting, every time the operation control signal is generated, the massaging parts to be operated from the plurality of massaging parts.

It is preferable that the selection part selects the massaging part operated by one of a plurality of selection rules for selecting the massaging part to be operated.

It is preferable to provide light emitting means which blinks in synchronization with the operations of the plurality of massaging parts. In this case, the user can feel a change of the sound signal not only as a stimulus from the massaging part but also as light through eyes, enhancing the healing effect.

### BRIEF DESCRIPTION OF THE DRAWINGS

FIG. 1 is a perspective view of a massage machine;

FIG. 2 is a block diagram of the massage machine;

FIG. 3 is a plan view of an operation device;

FIG. 4 is a circuit showing the main part of a pneumatic circuit;

FIG. 5 is a block diagram mainly showing a control circuit;

FIG. 6 is a circuit diagram showing the control circuit;

FIG. 7 is a waveform chart;

FIG. 8 is an explanatory drawing of operation modes;

FIG. 9 is an explanatory drawing showing a modification example of level modes;

FIG. 10 is a principle view showing a solenoid massaging part; and

FIG. 11 shows an operating state of the solenoid massaging part.

### BEST MODE FOR CARRYING OUT THE INVENTION

Hereinbelow, description will be made on an embodiment of the present invention with reference to the accompanying drawings.

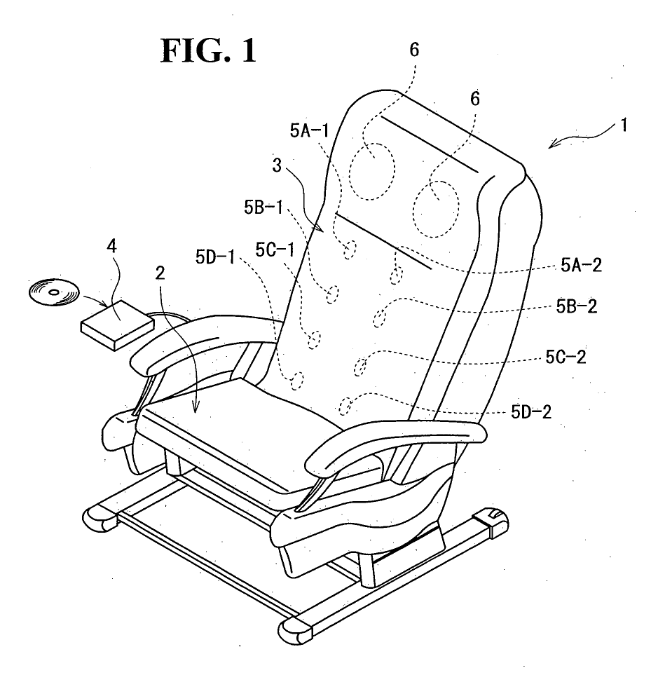

A massage machine 1 of FIG. 1 is configured as a massage chair including a seat 2 and a backrest 3. The massage machine 1 may further include, at the front of the seat 2, a footrest where legs are placed. The massage machine 1 further includes an operation device 4 for performing a variety of operations on the massage machine 1.

The backrest 3 includes a plurality of massaging parts 5 and speakers 6. In the massaging parts 5 of the present embodiment, air cells 5A-1, 5A-2, 5B-1, 5B-2, 5C-1, 5C-2, 5D-1 and 5D-2 are adopted as massage actuators. The air cells expand and contract in response to the supply and exhaust of air to press the body of the user. The massaging parts 5 may be provided on the seat 2 as well as the backrest 3. Further, massaging parts for massaging legs or arms of the user may be provided on the footrest or an armrest.

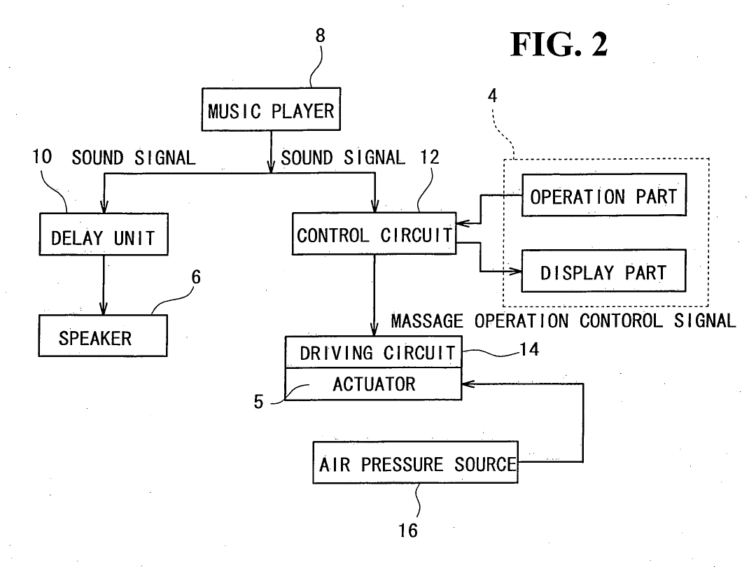

As shown in FIG. 2, the massage machine 1 includes a music player 8 for reproducing a sound signal (music signal) recorded on a recording medium such as a CD, a MD, a DVD and a hard disk. The music player 8 may be combined with the operation device 4 or separated from the operation device 4. The sound signal may not be obtained from the music player 8 provided in the massage machine but obtained from a sound source device (including an audio device, a microphone and the like) connected to an external input terminal provided on the massage machine 1.

The sound signal (analog signal or digital signal) outputted from the music player 8 is supplied to a delay unit 10 and a control circuit (control unit) 12. The delay unit 10 delays the sound signal of the music player 8 by a delay (for example, 60 msec) occurring during sound signal processing performed in the control circuit 12, and then the delay unit 10 outputs the sound signal to the speakers 6. This delay can eliminate a time lag between a sound outputted from the speakers and a massage.

The control circuit 12 fed with the sound signal generates a massage operation control signal based on the sound signal.

Further, the control circuit 12 is connected to the operation device 4. The operation device 4 includes an operation part for performing operations on the massage machine and a display part for displaying a state or the like of the massage machine.

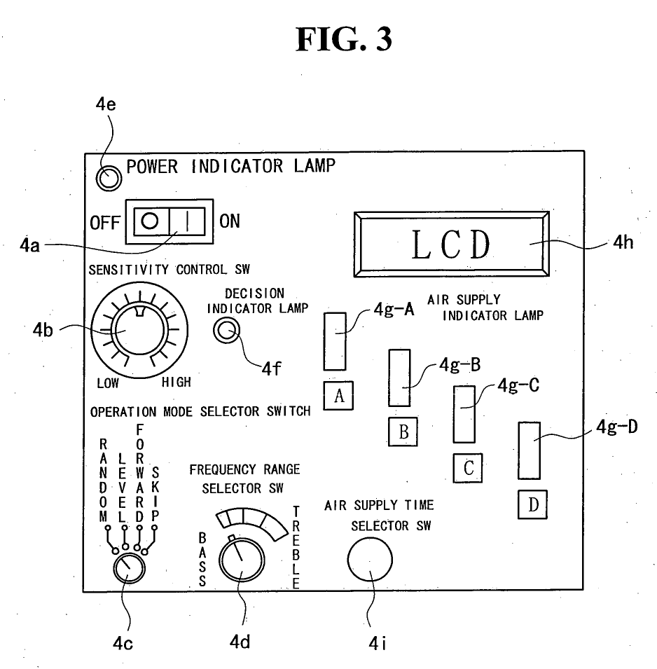

As shown in FIG. 3, the operation device 4 includes, as the operation part, a power switch 4a, a sensitivity control switch 4b, an operation mode selector switch 4c, a frequency range selector switch 4d, and an air supply time (massaging time) selector switch 4i.

The operation device 4 further includes, as the display part, a power indicator lamp 4e, a decision indicator lamp 4f, air supply indicator lamps 4g-A, 4g-B, 4g-C and 4g-D, and a liquid crystal display part 4h.

The power switch 4a is a power switch of the massage machine 1. When the power switch 4a is turned ON, the power indicator lamp 4e illuminates.

The sensitivity control switch 4b adjusts the degree of amplification of the sound signal, the amplification being performed by an amplifier 121, which will be described herein after. “Low” reduces the overall signal level of the sound signal and reduces the number of massages. “High” increases the overall signal level of the sound signal and increases the number of massages.

The decision indicator lamp 4f indicates a decision result of a voltage level decision circuit 121a for deciding the suitability of the sound signal. The decision indicator lamp 4f can display colors of blue, yellow and red. When blue is displayed, the signal level of the inputted sound signal is so high as to enable massage, which means that the sound signal is suitable. When yellow is displayed, the sound signal is inputted but the signal level (voltage) is low, and thus massage cannot be properly performed. When yellow is displayed, it is recommendable to operate the sensitivity control switch 4b (to “High”) to turn the decision indicator lamp 4f to blue. When red is displayed, the sound signal is not inputted.

The operation mode selector switch 4c is provided to switch and select the operation modes of massage. A plurality of operation modes are prepared with different rules for selecting the massaging parts 5 to operate. To be specific, “random” mode, “level” mode, “forward” mode, and “SKIP” mode are prepared. The state of the operation mode selector switch 4c is inputted to a computer 130. The detail of the modes will be described herein after.

The frequency range selector switch 4d is provided to select one of a plurality of filters in a frequency filter 122, described herein after, and makes it possible to adjust the frequency of sound to be sensed. For example, in the bass, a massage responding to bass such as a drum sound can be obtained. In the treble, a massage responding to a wide range of frequencies can be obtained.

The air supply time selector switch 4i is provided to adjust the duration (massaging time) of a massage time control signal generated in a first massage time control signal generation part 131 or a second massage time control signal generation part 132, described herein after. By adjusting the massaging time, the time of air supply to the air cells is increased and a massage can be performed with a larger pressing force.

The air supply indicator lamps 4g-A, 4g-B, 4g-C and 4g-D are provided to indicate the air cells supplied with air (operating massaging parts), and the liquid crystal display part 4h provides various displays relating to the operations of the massage machine.

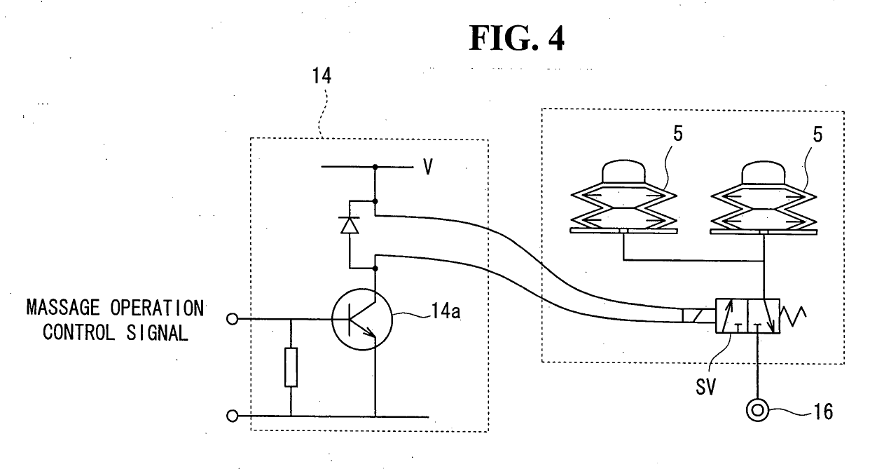

The massage operation control signal generated by the control circuit 12 is supplied to a driving circuit 14 of the air cell that serves as an air actuator 5. As shown in FIG. 4, when the driving circuit 14 is supplied with the massage operation control signal (High signal), a switching element (transistor) 14a is turned ON and the solenoid of an electromagnetic valve (switching valve) SV is energized by driving source power V and switched to an air supply state. On the other hand, when the massage operation control signal is not inputted to the driving circuit 14 (Low input to the driving circuit), the switching element 14a is turned OFF and the electromagnetic valve SV is switched to an exhaust state (the state of FIG. 4).

A pneumatic circuit for operating the air cells 5 includes an air pressure source (air supply source) 16 made up of an air pump and so on (made up of an accumulator when necessary) and the electromagnetic valve SV. When the electromagnetic valve SV is brought to an air supply state, air is supplied from the air pressure source 16 to the air cells 5 and the air cells 5 are expanded to press the user. On the other hand, when the solenoid of the electromagnetic valve SV is demagnetized to the exhaust state, air in the air cells 5 is exhausted (exhausted to the atmosphere) and the air cells 5 contract.

As shown in FIG. 1, in the present embodiment, four pairs of the air cells 5 are arranged in the longitudinal direction, that is, eight in total. The air cells 5 are laterally paired. For the pair of air cells, supply and exhaust are switched by a common electromagnetic valve (FIGS. 1, 4 and 5).

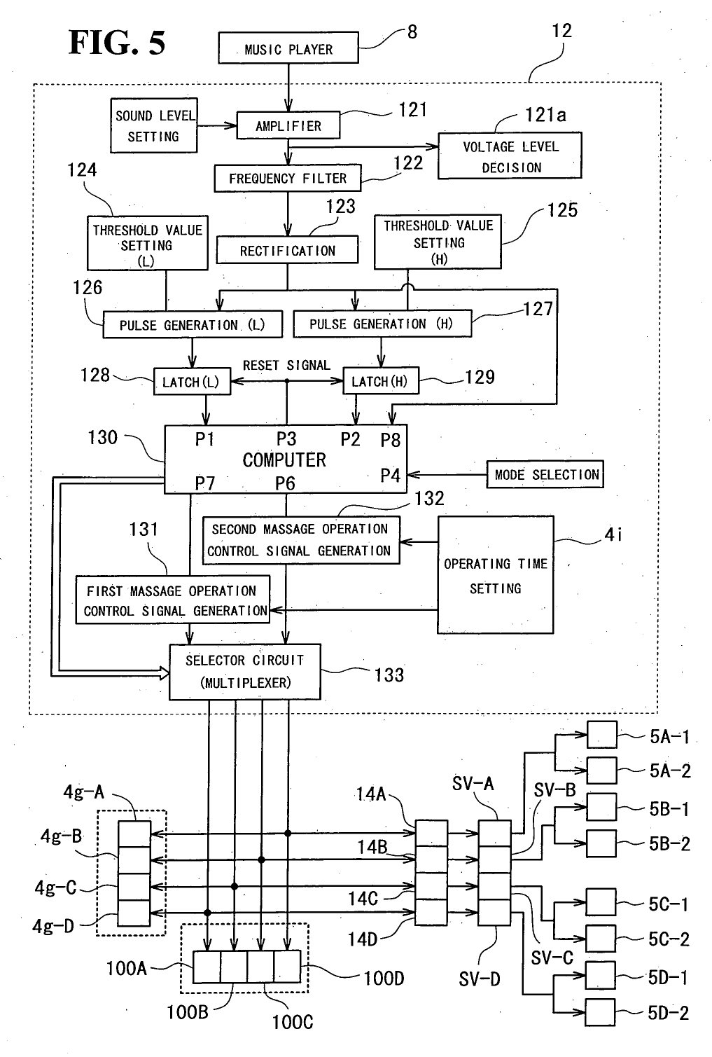

Hereinafter, the pairs of the air cells will be referred to as a first air cell group 5A (the pair of the air cells 5A-1 and 5A-2), a second air cell group 5B (the pair of the air cells 5B-1 and 5B-2), a third air cell group 5C (the pair of the air cells 5C-1 and 5C-2), and a fourth air cell group 5D (the pair of the air cells 5D-1 and 5D-2) in this order from the upper part of the backrest 3 (FIG. 5).

Further, an electromagnetic valve for switching supply and exhaust of the first air cell group 5A will be referred to as a first electromagnetic valve SV-A, an electromagnetic valve for switching supply and exhaust of the second air cell group 5B will be referred to as a second electromagnetic valve SV-B, an electromagnetic valve for switching supply and exhaust of the third air cell group 5C will be referred to as a third electromagnetic valve SV-C, and an electromagnetic valve for switching supply and exhaust of the fourth air cell group 5D will be referred to as a fourth electromagnetic valve SV-D (FIG. 5).

Moreover, a driving circuit of the first electromagnetic valve SV-A will be referred to as a first driving circuit 14A, a driving circuit of the second electromagnetic valve SV-B will be referred to as a second driving circuit 14B, a driving circuit of the third electromagnetic valve SV-C will be referred to as a third driving circuit 14C, and a driving circuit of the fourth electromagnetic valve SV-D will be referred to as a fourth driving circuit 14D (FIG. 5).

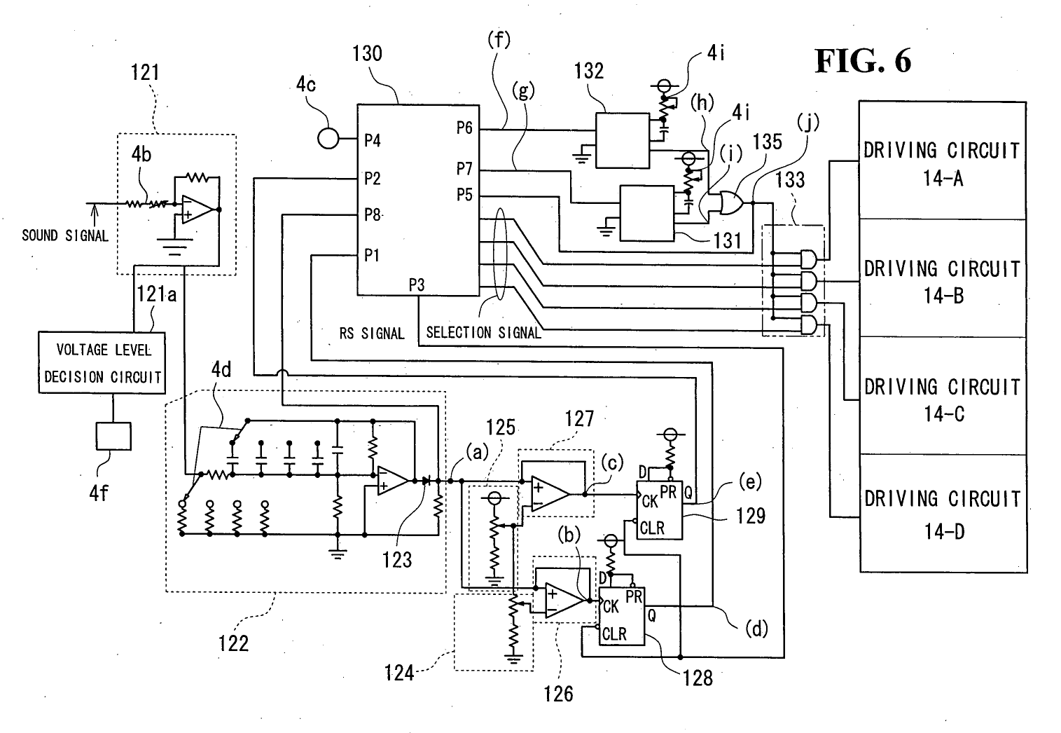

Referring to FIGS. 5 and 6, the detail of the control circuit 12 will be described below. The control circuit 12 includes an amplifier 121 for amplifying an inputted sound signal, a frequency filter (active filter) 122 for extracting the bass of the sound signal, a rectifying part 123 for rectifying the sound signal, a first threshold value setting part 124 for setting a first threshold value (Low threshold value) of the signal level of the sound signal, a second threshold value setting part 125 for setting a second threshold value (High threshold value) of the signal level of the sound signal, a first pulse generation part 126 for generating a pulse when the first threshold value is exceeded, a second pulse generation part 127 for generating a pulse when the second threshold value is exceeded, a first latching part 128 for latching the pulse generated by the first pulse generation part 126, a second latching part 129 for latching the pulse generated by the second pulse generation part 127, the computer 130 for performing various kinds of processing, a first massage operation control signal generation part 131 for generating a first massage operation control signal, a second massage operation control signal generation part 132 for generating a second massage operation control signal, and a selector circuit (selecting part) 133 for selecting the driving circuits 14A to 14D (massaging parts 5) to be supplied with the massage operation control signal.

The amplifier 121 can freely adjust the amplification degree of the sound signal. The amplifier 121 adjusts the amplification degree according to the sound signal level (voltage) fluctuating with the sound source, so that a massage start control signal or a massage operation control signal can be properly generated. The amplification degree can be adjusted by operating the sensitivity control switch 4b of the operation device 4.

The frequency filter 122 is made up of low-pass filters and provided to detect bass making up the rhythm of the sound signal (music signal). The frequency filter 122 can adjust a cutoff frequency. To be specific, the frequency filter 122 includes low-pass filters having cutoff frequencies of about 20 Hz, 50 Hz, 100 Hz, and 200 Hz, and the filters can be selected by operating the frequency range selector switch 4d of the operation device 4. When the cutoff frequency is reduced, a massage only responding to the bass can be obtained. When the cutoff frequency is increased, a massage relatively responding to the treble can be obtained.

The rectifying part 123 is provided to half-wave rectify the sound signal and is made up of a diode.

The first and second threshold value setting parts 124 and 125 are each made up of a variable resistor and configured to adjust a Low-side threshold value and a High-side threshold value.

The first pulse generation part 126 is made up of a comparator for generating a pulse when detecting that the inputted sound signal exceeds the Low-side threshold value set by the first threshold value setting part 124.

The second pulse generation part 127 is made up of a comparator for generating a pulse when detecting that the inputted sound signal exceeds the High-side threshold value set by the second threshold value setting part 125.

In the present embodiment, a state in which the sound signal exceeds the predetermined threshold value is regarded as a state to start a massage. When the pulse generation parts and 127 generate pulses, the sound signal is in a state to start a massage. In other words, the pulses generated by the pulse generation parts 126 and 127 act as massage start control signals.

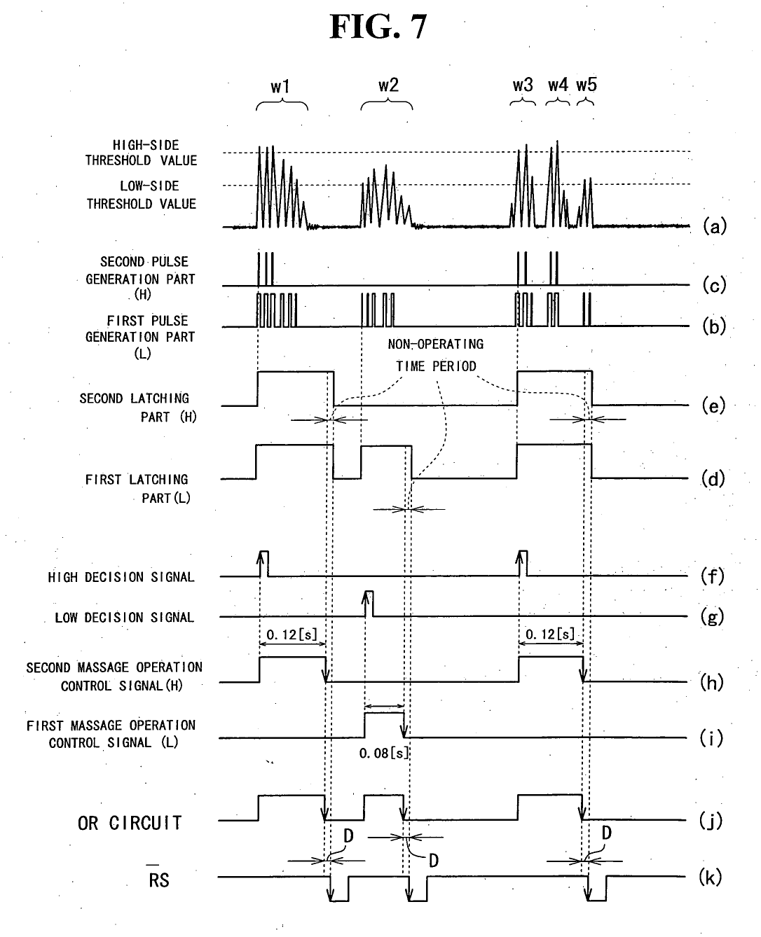

However, the signal level of the sound signal changes quite frequently, and thus the pulses generated by the first and second pulse generation parts 126 and 127 are oscillating pulses that are repeatedly turned ON/OFF in a short time (FIGS. 7(b) and 7(c)).

The first and second latching parts 128 and 129 are provided to latch the outputs of the first and second pulse generation parts 126 and 127, respectively. The outputs frequently vary in response to a change of the signal level of the sound signal. The first and second latching parts 128 and 129 are each made up of a D flip-flop. Since the pulses generated by the pulse generation parts 126 and 127 are oscillating, once the pulses are generated by the pulse generation parts 126 and 127, the latching parts 128 and 129 keep the High state of the output until the output of the latching part is reset by the computer 130 (FIGS. 7(d) and 7(e), specifically described herein after).

The latching parts 128 and 129 keep the High state of the pulse, so that the oscillating pulses are changed to stable pulses and the computer 130 can easily detect that the sound signal is brought a state to start a massage.

The computer 130 is made up of an 8-bit microcomputer and performs various kinds of processing using computer programs stored in a memory (not shown). The computer 130 decides whether or not the sound signal exceeds the threshold values (Low-side threshold value and High-side threshold value), for example, based on the outputs of the latching parts 128 and 129, and the computer 130 outputs a signal corresponding to the level (High or Low) of the sound signal (FIGS. 7(f) and (g)).

To be specific, the computer 130 decides whether the sound signal is lower than the Low-side threshold value, whether the sound signal is not lower than the Low-side threshold value and lower than the High-side threshold value, and whether the sound signal is not lower than the High-side threshold value. As a result of a decision of the computer 130, when the sound signal is not lower than the Low-side threshold value and lower than the High-side threshold value, a Low decision signal is outputted. When the sound signal is not lower than the High-side threshold value, a High decision signal is outputted.

The first massage operation control signal generation part 131 is made up of a one-shot multivibrator (74LS123) that can adjust a pulse length by means of external resistor and capacitor. When the Low decision signal is supplied from the computer 130 to the first massage operation control signal generation part 131, the first massage operation control signal is generated with a pulse length (duration) set at a first pulse length (for example, 0.08 [s]) (FIG. 7(i)).

The second massage operation control signal generation part 132 is also made up of a one-shot multivibrator (74LS123) that can adjust a pulse length by means of external resistor and capacitor. When the High decision signal is supplied from the computer 130 to the second massage operation control signal generation part 132, the second massage operation control signal is generated with a pulse length (duration) set at a second pulse length (for example, 0.12 [s]) (FIG. 7(h)).

The pulse lengths of the massage operation control signal generation parts 131 and 132 can be freely adjusted by the air supply time selector switch 4i.

Since the massage operation control signals have different durations, it is possible to vary the time of air supply (massaging time) to the air cells according to the signal level of the sound signal. In other words, when the signal level of the sound signal is relatively low (Low), air is supplied to the air cells for a relatively short time. When the signal level of the sound signal is relatively high (High), air is supplied to the air cells for a relatively long time.

As a result, when the signal level of the sound signal is relatively low, a massage occurs with a low pressure. When the signal level of the sound signal is relatively high, a massage occurs with a high pressure.

The air cells 5 are formed smaller than the conventional air cells for massage such that a substantially perfect expansion state can be obtained by air supply in the massaging time (0.12 [s] or 0.08 [s]) of one of the massage operation control signals.

The selector circuit 133 selects which one of the driving circuits 14A to 14D should be supplied with the generated first massage operation control signal or second massage operation control signal, based on a selection signal (specifically described herein after) outputted from the computer 130. The driving circuits 14A to 14D selected by the selector circuit 133 are fed with the first massage operation control signal or the second massage operation control signal, the selected electromagnetic valves SV-A to SV-D are switched to the air supply state for a time period corresponding to the pulse length of each massage operation control signal, and the selected air cells 5-A to 5-D are expanded.

Referring to FIG. 7, the flow of control of massage based on the sound signal will be described hereinbelow. First, the power switch 4a is turned ON, an operation mode is selected by the operation mode selector switch 4c, and the sound signal is generated by the music player 8. Further, the sound signal is adjusted by the sensitivity control switch 4b and the frequency range selector switch 4d when necessary.

When the sound signal is supplied from the music player to the control circuit 12, the signal is amplified by the amplifier 121. Next, a bass signal is extracted from the amplified sound signal by the frequency filter 122, and a signal or the like of the rhythm of music is extracted.

The filtered sound signal is half-wave rectified by the rectifying part 123. The half-wave rectified sound signal is shown in FIG. 7(a). FIG. 7(a) shows a waveform on point (a) of FIG. 6.

FIG. 7(a) also shows the Low-side threshold value set by the first threshold value setting part 124 and the High-side threshold value set by the second threshold value setting part 125.

The sound signal of FIG. 7(a) is inputted to the first and second pulse generation parts 126 and 127.

First, description will be made on the case where a part W1 of the sound signal of FIG. 7(a) is inputted. As shown in FIG. 7(b), the first pulse generation part 126 generates a pulse that is High while W1 of the sound signal exceeds the Low-side threshold value. The pulse is Low while W1 is lower than the Low-side threshold value. FIG. 7(b) shows a waveform on point (b) of FIG. 6.

As shown in FIG. 7(c), the second pulse generation part 127 generates a pulse that is High while W1 of the sound signal exceeds the High-side threshold value. The pulse is Low while W1 is lower than the High-side threshold value. FIG. 7(c) shows a waveform on point (c) of FIG. 6.

As described above, in the present embodiment, a state in which the sound signal exceeds the threshold value is regarded as a state to start a massage. As is evident from a fact that the pulses are oscillating in FIGS. 7(b) and (c), it is understood that the sound signal is frequently brought to a state not to start a massage immediately after the state to start a massage.

When the pulse of FIG. 7(b) is inputted to the first latching part 128 while the output of the first latching part 128 is Low, the output of the first latching part 128 is latched to High (FIG. 7(d); FIG. 7(d) shows a waveform on point (d) of FIG. 6).

Also, when the pulse of FIG. 7(c) is inputted to the second latching part 129 while the output of the second latching part 129 is Low, the output of the second latching part 129 is latched to High (FIG. 7(e); FIG. 7(e) shows a waveform on point (e) of FIG. 6).

A first input part P1 of the computer 130 is connected to the output of the first latching part 128 and a second input part P2 of the computer 130 is connected to the output of the second latching part 129. The signal level of the sound signal is decided based on input signals to the first input part P1 and the second input part P2.

In the decision of the signal level, it is first decided whether the input signal to the second input part P2 is High or not, that is, whether or not the signal level of the sound signal exceeds the high-side threshold value. When the input signal to the second input part P2 is High, the High decision signal is outputted.

When the input signal to the second input part P2 is Low, it is decided whether the input signal to the first input part P1 is High or not, that is, whether or not the signal level of the sound signal exceeds the Low-side threshold value. When the input signal to the first input part is High, the Low decision signal is outputted.

When the input signal to the first input part P1 is also Low, no signal is outputted.

In this case, the input signal to the second input part P2 is High in the W1 part of the sound signal, and thus the computer 130 outputs the High decision signal from a High decision signal output part P6 (FIG. 7(f); FIG. 7(f) shows a waveform on point (f) of FIG. 6).

When the High decision signal (pulse) is outputted from the computer 130, the second massage operation control signal generation part 132 generates the second massage operation control signal having a pulse length of 0.12 [s] while applying the rising edge of the High decision signal as a one-shot trigger (FIG. 7(h); FIG. 7(h) shows a waveform on point (h) of FIG. 6).

The second massage operation control signal is supplied to the selector circuit 133 through an OR circuit 135 and operates the driving circuits 14A to 14D selected by the selector circuit 133. The output of the OR circuit 135 is shown in FIG. 7(j). FIG. 7(j) shows a waveform on point (j) of FIG. 6.

As a result, the second massage operation control signal which continues for 0.12 [s] is generated according to the W1 part, in which the signal level of the sound signal is relatively high, and the selected air cells 5A to 5D are expanded to press the user for 0.12 [s]. At the end of the second massage operation control signal, the expanded air cells contract.

Moreover, the computer 130 receives the output of the OR circuit (the logical add of the first massage operation control signal and the second massage operation control signal) and generates a reset (RS) signal for resetting (setting at Low) the outputs of the first latching part 128 and the second latching part 129.

The reset signal is generated applying the falling edge of the output of the OR circuit (the falling edge of the first massage operation control signal or the falling edge of the second massage operation control signal) as a trigger. The reset signal is substantially delayed by a predetermined time D from the trigger (FIG. 7(k); FIG. 7(k) shows a waveform on point (k) of FIG. 6).

The reset signal is generated after the end of the massage operation control signal, so that the High state of the outputs of the latching parts 128 and 129 is kept longer than the massage operation control signal.

In this case, the computer 130 is configured to output the High decision signal or the Low decision signal when the outputs of the latching parts 128 and 129 change from Low to High. Thus when the outputs of the latching parts 128 and are kept at High, even a change of the sound signal does not allow the computer 130 to decide the level of the sound signal.

In other words, when the outputs of the latching parts and 129 are High, the computer 130 acting as a processor is in a state of insensitivity to a change of the sound signal.

In the present embodiment, the computer 130 is in a state of insensitivity not only when the first massage operation control signal or the second massage operation control signal is generated but also in the predetermined delay time D after the end of the massage operation control signal.

In a state of insensitivity, even when the sound signal is brought to a state to start a massage (exceeding the threshold value), the massage operation control signal is not generated, and thus a massage is not performed. In other words, a time corresponding to the delay time D immediately after the end of the massage operation control signal having the predetermined massaging time (0.12 [s] or 0.008 [s]) is a non-operating time period D during which the massaging parts 5 are not operated.

Then, description will be made on the case where a W2 part, following the W1 part of the sound signal, is inputted. The W2 part appears while the outputs of the latching parts 128 and 129 are reset (FIGS. 7(d) and 7(e)), and thus the W2 part is a target to be latched by the latching parts 128 and 129.

In other words, the W2 part of the sound signal exceeds the Low-side threshold value but does not exceed the High-side threshold value (FIG. 7(a)). Thus only the output of the first latching part 128 is set at High (FIG. 7(d); FIG. 7(d) shows a waveform on point (d) of FIG. 6) and the Low decision signal is outputted by the decision of the computer 130 (FIG. 7(g); FIG. 7(g) shows a waveform on point (g) of FIG. 6).

The first massage operation control signal generation part 131 having received the Low decision signal generates the first massage operation control signal with a pulse length of 0.08 [s] while applying the rising edge of the Low decision signal as a one-shot trigger (FIG. 7(i); FIG. 7(i) shows a waveform on point (i) of FIG. 6).

The first massage operation control signal is supplied to the selector circuit 133 through the OR circuit 135 and operates the selected driving circuits 14A to 14D.

As a result, the first massage operation control signal continuing for 0.08 [s], which is relatively short, is generated according to the W2 part in which the signal level of the sound signal is relatively low, and the selected air cells 5A to 5D are expanded for 0.08 [s].

Since the duration of the first massage operation control signal is shorter than that of the second massage operation control signal, air is supplied to the air cells for a short time and only a relatively small expansion can be obtained, resulting in a massage with a lower pressure. Conversely, the duration of the second massage operation control signal is longer and results in a massage with a higher pressure.

Furthermore, description will be made on the case where W3, W4 and W5 parts following the W2 part of the sound signal are inputted.

As shown in FIG. 7, the W3 part of the sound signal sets the outputs of the first latching part 128 and the second latching part 129 at High. Thus the computer 130 decides that the sound signal exceeds the High-side threshold value, outputs the High decision signal, and outputs the second massage operation control signal.

Next, the subsequent rise W4 of the sound signal appears during the generation of the second massage operation control signal. However, the outputs of the latching parts 128 and are latched and thus the computer 130 does not perform the decision of the signal and extend the massaging time.

Further, a rise W5 of the sound signal acts as a signal exceeding the Low-side threshold value (a state to start a massage) after the end of the second massage operation control signal. Since W5 appears in a non-operating time period before the outputs of the latching parts 128 and 129 are reset, the computer 130 does not perform the decision of the signal. Therefore, even in the presence of W5, the massage operation control signal is not generated.

As described above, even when the sound signal exceeds the threshold value (even in a state to start a massage) immediately after the end of the massage operation control signal (the end of the massaging time), the massaging parts do not operate in the non-operating time period D. In other words, in the non-operating time period D, it is possible to obtain a time of exhaust from the air cells 5 (the time of the retreat of the massaging parts), achieving a varied pressing operation.

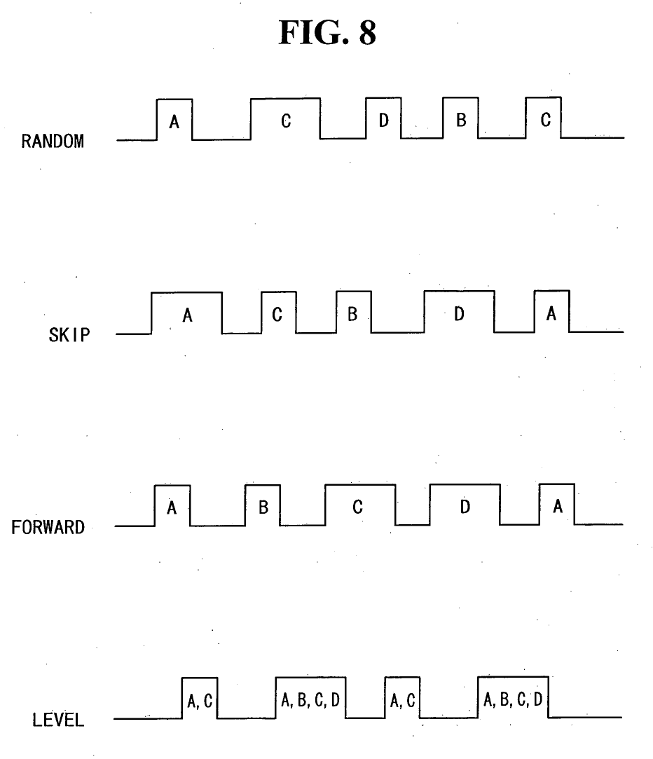

FIG. 8 shows operations in operation modes selected by the operation mode selector switch 4c. The computer 130 has a computer program for generating a selection signal in each operation mode in response to the selection of the operation mode selector switch 4c. The selection signal in each operation mode is outputted from the computer 130 and supplied to the selector circuit 133 based on the program.

Moreover, every time the first massage operation control signal or the second massage operation control signal is generated, the computer selects the air cells to be operated from the four air cell groups 5A to 5D, so that the massaging parts are selected according to a change of the sound signal.

In “random” operation mode, the air cell groups randomly selected from the four air cell groups 5A to 5D are operated. In other words, a target to be selected is randomly determined such that an air cell group A is selected for the first operation control signal, an air cell group C is selected for the second operation signal, and an air cell group D is selected for the third operation control signal, and the like.

In “SKIP” operation mode, every other air cell group is sequentially selected from the upper part of the backrest 3 and the selected air cell groups are operated. In other words, every other air cell group is sequentially determined as a target to be selected such that the air cell group A is selected for the first operation control signal, the air cell group C skipped from the air cell group A is selected for the second operation control signal, the air cell group B is selected for the third operation control signal, and the air cell group D skipped from the air cell group B is selected for the fourth operation control signal, and the like.

In “forward” operation mode, the air cells are sequentially selected from the upper part of the backrest and the selected air cell groups are operated. In other words, targets to be selected are sequentially determined from the upper part such that the air cell group A is selected for the first operation control signal, the air cell group B is selected for the second operation control signal, the air cell group C is selected for the third operation control signal, and the air cell group D is selected for the fourth operation control signal, and the like.

In the three operation modes, only one air cell group is selected at a time. However, in “level” operation mode, the number of air cell groups (massaging parts) selected according to the signal level of the sound signal also changes. In other words, targets to be selected are determined as follows; for example, in the case of the first massage operation control signal corresponding to a low sound signal, two air cell groups (for example, the air cell group A and the air cell group C) are operated, and in the case of the second massage operation control signal corresponding to a strong sound signal, the four air cell groups are operated.

As in “level” operation mode, the number of operating massaging parts is changed with the state of the sound signal, further improving synchronization between music and a massage.

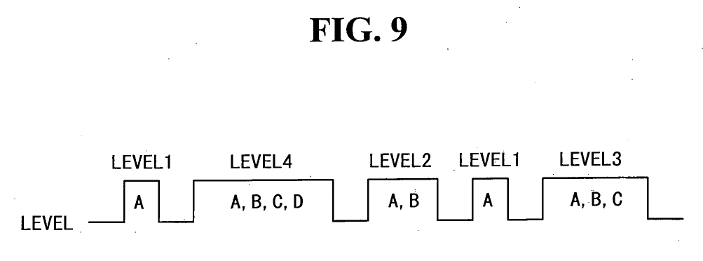

FIG. 9 shows a modification example of “level” operation mode. As shown in FIG. 9, in the case of four levels, the rectification signal of music can be captured to the computer (see a port P8 of FIGS. 5 and 6), and the signal can be also used by analysis.

Further, in the modification example of FIG. 9, four levels of level 1, level 2, level 3, and level 4 are set in increasing order of signal level as threshold values of the sound signal, and operation control signals with different durations are generated according to the four levels. In this case, the air cell group A is selected for level 1, the two air cell groups A and B are selected for level 2, and the three air cell groups are selected for level 3, and the four air cell groups are selected for level 4.

In response to the modes such as the modes described above, when the selection signal is supplied from the computer 130 to the selector circuit 133, the massage operation control signals are supplied in the selector circuit (AND gate) 133 to the driving circuits 14A to 14D corresponding to the selected air cell groups.

Further, the massage operation control signals having passed through the selector circuit 133 are also supplied to the air supply indicator lamps 4g-A (corresponding to the air cell group A), 4g-B (corresponding to the air cell group B), 4g-C (corresponding to the air cell group C), 4g-D (corresponding to the air cell group D) of the operation device 4. While air is supplied to the corresponding air cell group, the air supply indicator lamp illuminates. When air is not supplied to the corresponding air cell group, the air supply indicator lamp turns off.

Moreover, light emitting means blinking in synchronization with the air cell groups (massaging parts) may be made up of lamps 100A to 100D provided on the other parts of the massage machine, except for air supply indicator lamps provided on parts other than the operation device 4.

According to the massaging machine of the present embodiment, it is possible to improve synchronization between the sound signal (music signal) and a massage and synchronize the switching of the massaging parts and a change of music.

Further, according to the massage machine of the present embodiment, the user can feel a change of the sound signal as a sound through ears, as a press through the body, and as light through eyes, thereby enhancing the healing effect.

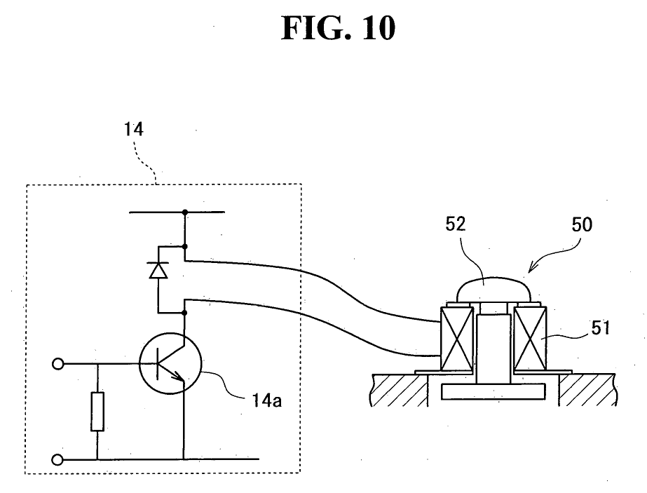

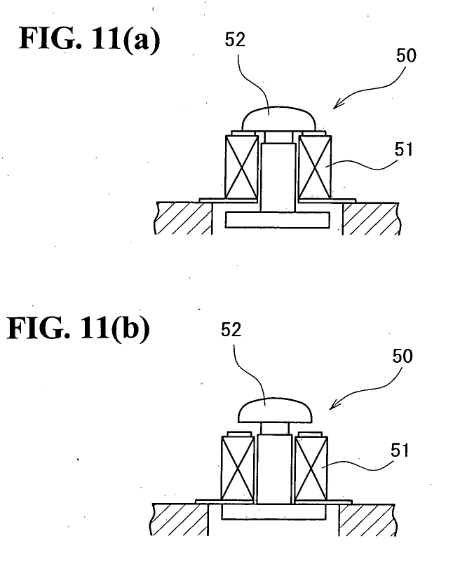

FIG. 10 and FIG. 11 show a modification example of the massaging part. A massaging part 50 includes a treatment part 52 driven by a solenoid 51. When the switching element 14a of the driving circuit 14 is turned ON by the massage operation control signal, the solenoid 51 is driven by excitation and the treatment part 52 protrudes to the front to press the body (FIG. 11(b)). On the other hand, when the switching element 14a of the driving circuit 14 is turned OFF, the solenoid 51 is demagnetized and the treatment part 52 is moved back by the urging force of a spring which is not shown (FIG. 11(a)).

In the conventional air massage machine (the air massage machine described in Japanese Patent Laid-Open No. 2003-79687), although a massage faithfully changing with a change of a sound signal can be obtained, the feeling of the massage may not be enough.

For example, in the case of a short interval from when the sound signal exceeds a threshold value to when the sound signal falls below the threshold value, the air pump is driven for a short time and thus a sufficient amount of air is not supplied to the air bags. In this case, the air bags only slightly expand and thus only a weak massage can be obtained.

In other words, in the case of air bags (air cells) expanded by air supply, it is necessary to supply air for a relatively long time to obtain a strong pressing force. Meanwhile, the sound signal changes in an extremely short time, and thus when the sound signal exceeds the threshold value for a short time, a sufficient pressing force cannot be obtained.

As a result, even in the case of a high sound signal level, when the signal level is high for a short time, only a weak massage can be obtained, causing a gap between the feeling of the massage and a change of the sound signal.

Such a problem similarly occurs not only when the massaging part is an air cell but also when the massaging part requires a certain time for a massage.

Thus it is an object of the present invention to provide a massage machine that obtains a sufficient operating time for a massaging part when the massaging part is operated based on a sound signal.

As described above, the present invention includes the massaging parts 5 for performing a massage and the control circuit 12 for performing control such that a massage corresponding to a change of the sound signal is performed in the massaging parts 5. When detecting that the sound signal is brought to a predetermined state to start a massage by a change of the sound signal, the control circuit 12 brings the massaging parts 5 to an operating state during a predetermined massaging time regardless of the change of the sound signal.

Therefore, even when the sound signal is brought out of the state to start a massage immediately after the sound signal is brought to the predetermined state to start a massage by a change of the sound signal, once the sound signal is brought to the state to start a massage, the massaging parts are brought to the operating state during the predetermined massaging time regardless of the subsequent change of the sound signal.

Thus, even when the state of the sound signal changes in an extremely short time, it is possible to obtain a sufficient operating time for the massaging parts.

Moreover, in the conventional air massage machine (the air massage machine described in Japanese Patent Laid-Open No. 2003-79687), the air bags (air cells) supplied with air are switched independently of a change of the sound signal, so that the switching of the expanding air bags and the rhythm of music are irrelevant to each other.

Thus it is an object of the present invention to improve the massaging effect by relating the switching of the operating massaging parts to a change of the sound signal.

As described above, the present invention includes the plurality of massaging parts 5 for performing a massage and the control circuit 12 for controlling the massaging parts 5. The control circuit 12 selects, based on a change of the sound signal, the massaging parts 5 to be brought to the operating state from the plurality of massaging parts 5.

Thus the massaging parts to be brought to the operating state are selected from the plurality of massaging parts based on a change of the sound signal, so that the user can feel a change of the sound signal also from a change of the operating massaging parts, improving a correlation between the sound signal and a massage.

Also, the present invention is not limited to the foregoing embodiment.

The massage machine may be provided in various forms including a mat and boots.

The massaging part is not limited to a pressing type using air cells or solenoids. The massaging part may perform massages such as kneading, patting, and vibrations or provide a relaxing effect by swinging the body.

The sound signal is not limited to music and any other sound signals may be used.

Further, the massage machine may include massaging parts operating independently of a sound signal.

1. A massage machine comprising:
a massaging part for performing a massage, and
a control unit for performing control such that a massage corresponding to a change of a sound signal is performed in the massaging part, and
when the control unit detects that the sound signal is brought to a predetermined state to start a massage by a change of the sound signal, the control unit brings the massaging part to an operating state during a predetermined massaging time regardless of the change of the sound signal.

2. The massage machine according to claim 1, wherein the control unit comprising:
a massage start control signal generation part for detecting that the sound signal is brought to the predetermined state to start a massage and generating a massage start control signal, and
a massage operation control signal generation part for generating, when the massage start control signal is generated, a massage operation control signal for operating the massaging part during the predetermined massaging time.

3. The massage machine according to claim 1, wherein the control unit is configured to have a non-operating time period in which even when the sound signal is brought to the state to start a massage immediately after the massaging time, the massaging part does not operate again.

4. The massage machine according to claim 1, wherein the control unit detects, as a state to start a massage of the sound signal, a plurality of states to start a massage with various states of the sound signal, and
the massage is varied with the detected states to start a massage.

5. The massage machine according to claim 3, wherein the control unit detects, as a state to start a massage of the sound signal, a plurality of states to start a massage with various states of the sound signal, and
the massage is varied with the detected states to start a massage.

6. The massage machine according to claim 4, the massage is varied by changing the massaging time according to the detected states to start a massage.

7. The massage machine according to claim 1, wherein the control unit comprising:
a massage start control signal generation part for generating a first massage start control signal when the sound signal is brought to a first massage start state and generating a second massage start control signal when the sound signal is brought to a second massage start state which is different from the first massage start state, and
a massage operation control signal generation part for generating, when the first or second massage start control signal is generated, a massage operation control signal for operating the massaging part during the predetermined massaging time, and
the massage operation control signal generation part is configured such that a massaging time of the massage operation control signal generated in response to the first massage start control signal and a massaging time of the massage operation control signal generated in response to the second massage start control signal are different in length.

8. The massage machine according to claim 1, wherein the massaging part is configured as an air massaging part for performing a massage in response to air supply from an air supply source, and
the control unit is configured to supply air to the air massaging part such that the air massaging part can expand so large as to press a body during the massaging time.

9. The massage machine according to claim 1, wherein the massaging part is made up of an air cell expanded by air supply from an air supply source and the air cell substantially finishes expanding in an air supply time of 0.5 seconds or less.

10. A massage machine comprising:
a plurality of massaging parts for performing a massage, and
a control unit for controlling the massaging parts,
and
the control unit selects, based on a change of a sound signal, the massaging parts to be operated from the plurality of massaging parts.

11. The massage machine according to claim 10, wherein the control unit comprising:
an operation control signal generation part for generating an operation control signal of the massaging part based on a change of the sound signal, and
a selection part for selecting, every time the operation control signal is generated, the massaging parts to be operated from the plurality of massaging parts.

12. The massage machine according to claim 10, wherein the selection part selects the massaging part by one of a plurality of selection rules for selecting the massaging part to be operated.

13. The massage machine according to claim 10, comprising light emitting means which blinks in synchronization with operations of the plurality of massaging parts.

14. The massage machine according to claim 2, wherein the control unit is configured to have a non-operating time period in which even when the sound signal is brought to the state to start a massage immediately after the massaging time, the massaging part does not operate again.

15. The massage machine according to claim 2, wherein the control unit detects, as a state to start a massage of the sound signal, a plurality of states to start a massage with various states of the sound signal, and
the massage is varied with the detected states to start a massage.

16. The massage machine according to claim 5, the massage is varied by changing the massaging time according to the detected states to start a massage.

17. The massage machine according to claim 2, wherein the control unit comprising:
a massage start control signal generation part for generating a first massage start control signal when the sound signal is brought to a first massage start state and generating a second massage start control signal when the sound signal is brought to a second massage start state which is different from the first massage start state, and
a massage operation control signal generation part for generating, when the first or second massage start control signal is generated, a massage operation control signal for operating the massaging part during the predetermined massaging time, and
the massage operation control signal generation part is configured such that a massaging time of the massage operation control signal generated in response to the first massage start control signal and a massaging time of the massage operation control signal generated in response to the second massage start control signal are different in length.

18. The massage machine according to claim 2, wherein the massaging part is configured as an air massaging part for performing a massage in response to air supply from an air supply source, and
the control unit is configured to supply air to the air massaging part such that the air massaging part can expand so large as to press a body during the massaging time.

19. The massage machine according to claim 2, wherein the massaging part is made up of an air cell expanded by air supply from an air supply source and the air cell substantially finishes expanding in an air supply time of 0.5 seconds or less.

20. The massage machine according to claim 11, wherein the selection part selects the massaging part by one of a plurality of selection rules for selecting the massaging part to be operated.
